(19) United States
(12) Patent Application Publication
(10) Pub. No.: US 2005/0253980 A1
(43) Pub. Date: Nov. 17, 2005

(54) Liquid crystal display device

(76) Inventors: Ken Saito, Mobara (JP); Shigeo Shimamo, Chosei (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/098,455

(22) Filed: Apr. 5, 2005

(30) Foreign Application Priority Data
Apr. 7, 2004 (JP) 2004-113311

(51) Int. Cl. G02F 1/1335; G02F 1/1333

(52) U.S. Cl. 349/64; 349/58

(57) ABSTRACT

A liquid crystal display device includes a plurality of light emitting diodes mounted on a side wall of a light guide plate so as to irradiate light inside of the light guide plate. On a light reflection surface of the light guide plate, a plurality of light reflection patterns having concentric grooves about the light emitting diodes in the direction equal to the advancing direction of respective main light beams of the light emitting diodes are formed in a state that the plurality of light reflection patterns are divided into a first light reflection pattern region and a second light reflection pattern region respectively corresponding to the light emitting diodes. Between the first light reflection pattern region and a second light reflection pattern region, a light reflection pattern intersecting region where end portions of the light reflection patterns intersect each other is defined.

### CROSS-REFERENCE TO RELATED APPLICATIONS

The disclosure of Japanese Patent Application No. 2004-113311 filed on Apr. 7, 2004 including the specification, drawings and abstract is incorporated herein by reference in its entirety.

### BACKGROUND OF THE INVENTION

The present invention relates to a liquid crystal display device, and more particularly to a liquid crystal display device having a light guide plate which diffuses a light-source light of a solid light emitting element such as a light emitting diode or the like as a light source in a developed manner on a back surface of a liquid crystal display panel in a planer shape.

Recently, with respect to a miniaturized portable digital assistant such as a mobile phone, a portable information terminal or the like, a liquid crystal display device which is small-sized and exhibits the low power consumption has been popularly used as a display device. As this type of liquid crystal display device, a liquid crystal display device having the structure which uses an external light as illumination means for visualizing an electronic latent image formed on a liquid crystal display panel or the structure which installs an auxiliary illumination device on a front-surface side or a back-surface side of the liquid crystal display panel has been used. The auxiliary illumination device which is installed on the back-surface side of the liquid crystal display panel is referred to as a back light device, while the auxiliary illumination device which is installed on the front-surface side of the liquid crystal display panel is referred to as a front light device.

As such a light source for the auxiliary illumination device of the miniaturized portable digital assistant, there has been known a light source which has the following structure. That is, the light source has a light guide plate which arranges a cold cathode fluorescent lamp on a side wall (side edge) side as in the case of a notebook type personal computer or the like which has a relatively large display screen size. However, in the mobile telephone or the miniaturized portable digital assistant (so-called, PDA or the like), in place of the above-mentioned cold cathode fluorescent lamp, a solid light emitting element as represented by a light emitting diode (LED) which exhibits the small power consumption is popularly used.

In the backlight device which uses the light emitting diode as a light source, with respect to a light reflection pattern which is applied to the light guide plate for efficiently converting light emitted from the light emitting diode which constitutes a spot light source into a face light source, various shapes have been proposed. Concentric light reflection patterns which are arranged around a spot light source exhibit the highest efficiency. A drawback that the concentric light reflection pattern possesses lies in that when a plurality of light emitting diodes are used as the light source, there arise portions where the concentric light reflection patterns are overlapped to each other and respective enterprises concerned have been carrying out researches and developments on counter measures to cope with the brightness irregularities of these portions.

FIG. 10 is a cross-sectional view of an essential part for schematically explaining a constitutional example of a liquid crystal display device having a backlight device which uses a light emitting diode as a light emitting element on a light guide plate. This type of backlight device BL is configured such that a plurality of light emitting diodes LED are arranged to face in an opposed manner a side wall (side edge) of the light guide plate GLB made of a light-transmitting resin material or the like which is installed on a back-surface side of the liquid crystal display panel PNL. Further, a light diffusion sheet DIS is adhered to and arranged on a front surface of the light guide plate GLB, while a light reflection sheet RES is adhered to and arranged on a back surface of a light guide plate GLB. Here, the light emitting diodes LED are mounted on a printed circuit board PCB in an erected manner.

A hard printed circuit board, a flexible printed circuit board or the like is used as a printed circuit board PCB. Although not shown in the drawing, on a back-surface side (a surface opposite to the light emitting diodes LED) of the printed circuit board PCB, a drive IC, other electronic parts EP and the like are mounted. The light emitting diodes LED are arranged in a state that light emitting portions E are brought into contact with a side edge of the light guide plate GLB. Light which is emitted from the light emitting portions E of the light emitting diodes LED is introduced into the inside of the light guide plate GLB which uses the side edge as a light incident surface.

The light guide plate GLB is, as shown in FIG. 11 which is a plan view of an essential part, configured such that a plurality of radial diffusion patterns DIP are formed on a light emitting surface which is formed on the front surface of the light guide plate GLB thus forming a light diffusion surface DIF on the light emitting surface. The diffusion patterns DIP are constituted of a plurality of diffusion regions DIA, wherein each diffusion region DIA is formed as a semi-columnar recessed portion on the light diffusion surface of the light guide plate GLB. Further, the diffusion patterns DIP are constituted of a first region R1 and a second region R2 which are respectively formed on an approximately lower half and an approximately upper half of the light diffusion surface DIF and a transitional region RT which is formed between the first region R1 and the second region R2 with respect to a longitudinal center line C of the light guide plate GLB.

A direction of an axis AX of the whole diffusion regions DIA in the first region R1 (hereinafter referred to as an axial direction of the diffusion regions) is aligned with a tangential direction of a circle which has the center on the first light emitting diode LED1 in a plan view, while a direction of an axis of whole diffusion regions in the second region R2 is aligned with the tangential direction of a circle which has the center on the first light emitting diode LED2 in a plan view.

That is, the light guide plate GLB is configured such that light incident from the plurality of light emitting diodes LED1, LED2 propagates in the inside of the light guide plate, and, at the same time, the light is diffused by a large number of diffusion regions DIA formed on the light diffusion surface DIF and, thereafter, is irradiated from a light irradiation surface. The diffusion patterns DIP which constitute a layout pattern of a large number of diffusion regions DIA includes a plurality of sub layout pattern regions R1, R2 which are formed of the diffusion regions DIA which are arranged in a state that the respective directivities of diffusion (axial directions of the diffusion regions) are made relevant to the incident light from the plurality of light emitting diodes LED1, LED2. Further, the directivities of the diffusion (the axial directions of the diffusion regions) of the diffusion regions DIA in the neighboring sub layout pattern regions R1, R2 are transitioned from one directivity to another directivity by way of a transition region RT. Accordingly, it is possible to suppress the generation of boundary lines in contrast on the irradiation surface of the output light as viewed from any azimuths and hence, the light which is irradiated to a back surface of the liquid crystal display panel PNL can provide a uniformly bright display screen.

Here, the liquid crystal display device which is constituted of the liquid crystal display panel PNL shown in FIG. 10 and the light guide plate GLB on which the plurality of the light diffusion patterns DIP formed of the plurality of diffusion regions DIA which diffuse the emitted light of the light emitting diode LED which are arranged on the back surface side of the liquid crystal display panel PNL are formed is, for example, disclosed in Japanese Patent Laid-open No. 149639/2003 (literature 1).

### BRIEF SUMMARY OF THE INVENTION

However, in the liquid crystal display device having such a constitution, to consider the principle of the diffusion patterns DIP, it is indispensable that the diffusion patterns DIP receive the light from the light emitting diodes LED1, LED2 perpendicularly. However, the diffusion patterns DIP in the transitional region RT portion do not always receive the light from the light emitting diodes LED1, LED2 perpendicularly and hence, there has been a drawback that in the observation direction (viewing-angle direction) on the light irradiation surface, a boundary is apparently generated between the layout pattern region R1 and the layout pattern region R2 whereby the brightness irregularities are generated on the liquid crystal display panel PNL.

Accordingly, the invention has been made to overcome the above-mentioned drawbacks of the related art and it is an object of the invention to provide a liquid crystal display device which can realize a beautiful image display with high brightness and no brightness irregularities by allowing light to impinge on light reflection patterns which are formed on a light reflection surface of a light guide plate perpendicularly thus eliminating the generation of a boundary between arrangement pattern regions in the viewing angle direction on a light irradiation surface of the light guide plate.

To achieve such an object, a liquid crystal display device according to the invention includes a liquid crystal display panel being configured to sandwich a liquid crystal layer between a pair of transparent substrates which have electrodes for forming pixels on inner surfaces thereof; a light guide plate which is mounted on a back surface of the liquid crystal display panel and includes a light irradiation surface which diffuses light by developing the light in a planar shape on a front surface thereof which faces the liquid crystal display panel in an opposed manner and a light reflection surface which reflects light to the light irradiation surface on a back surface thereof arranged opposite to the light irradiation surface; and a plurality of light emitting elements which are mounted on a side wall of the light guide plate and irradiate light in the inside of the light guide plate, wherein on the light reflection surface of the light guide plate, a plurality of light reflection patterns having concentric grooves about the light emitting elements in the direction equal to the advancing direction of respective main light beams of the light emitting elements are formed in a state that the plurality of light reflection patterns are divided into a first light reflection pattern region and a second light reflection pattern region corresponding to the light emitting elements respectively, and between the first light reflection pattern region and a second light reflection pattern region, a light reflection pattern intersecting region where end portions of the light reflection patterns intersect each other is defined. Due to such a constitution, light from the respective light emitting elements impinges on the respective light reflection patterns perpendicularly and hence, a boundary between the first light reflection pattern region and the second light reflection pattern region in the viewing angle direction on the light irradiation surface of the light guide plate is hardly generated whereby it is possible to overcome the drawbacks of the related art.

Further, according to the invention, in the above-mentioned constitution, the arrangement pitch of the light reflection patterns is formed at an equal interval and a depth of the grooves is increased as the light reflections patterns are separated from the light emitting elements. Accordingly, a light reflection quantity is increased in the direction spreading from front surfaces of the respective light emitting elements and hence, the in-plane brightness in the viewing angle direction can be made uniform whereby it is possible to overcome the drawback of the related art.

Further, according to the invention, in the above-mentioned constitution, the light reflection pattern intersecting region has a region thereof set to a range of 5% to 15% of a distance between the light emitting elements and hence, a boundary is hardly generated between the arrangement pattern regions whereby it is possible to overcome the drawback of the related art.

Further, according to the invention, in the above-mentioned constitution, a depth of the grooves of the light reflection patterns formed in the light reflection pattern intersecting region is set larger than a depth of the grooves of the light reflection patterns formed in the first light reflection pattern region and the second light reflection pattern region. Accordingly, the light reflection quantity is increased in the direction spreading from front surfaces of the respective light emitting elements and hence, the in-plane brightness in the viewing angle direction can be made uniform whereby it is possible to overcome the drawback of the related art.

Here, the invention is not limited to the above-mentioned constitutions and various modifications can be made without departing from the gist of the invention.

### BRIEF DESCRIPTION OF THE SEVERAL VIEWS OF THE DRAWING

FIG. 1 is a developed perspective view of the constitution of an essential part excluding a liquid crystal display panel and a housing case for explaining an embodiment 1 of a liquid crystal display device according to the invention;

FIGS. 2A and 2B are explanatory views showing a state in which a light guide plate is housed in a mold case shown in FIG. 1 and a printed circuit board which mounts a light emitting diode thereon is assembled to the mold case integrally;

FIG. 3 is a plan view for explaining the constitution of an embodiment of a light guide plate according to the liquid crystal display device of the invention;

FIG. 4 is a plan view of the light guide plate for explaining the relationship of a size between light emitting diodes and a distance of a light reflection pattern intersecting region;

FIGS. 5A-5D are views for explaining an example of the formation of grooves having an approximately V-shaped cross section formed on a light reflection surface of the light guide plate;

FIG. 6 is a view showing the groove distribution of the grooves having the approximately V-shaped cross section formed on the light reflection surface of the light guide plate;

FIGS. 7A and 7B are cross-sectional views of an essential part showing the structure of a light incident surface of the light guide plate;

FIG. 8 is a plan view for explaining the constitution of another embodiment of the light guide plate according to a liquid crystal display device of the invention;

FIGS. 9A and 9B are views for explaining a structural example of a mobile phone in which a liquid crystal module is mounted on a light guide plate;

FIG. 10 is a cross-sectional view of an essential part for schematically explaining a constitutional example of a conventional liquid crystal display device having a backlight device which uses a light emitting diode on a light guide plate; and

FIG. 11 is a plan view of an essential part showing the constitution of a light diffusion surface of the light guide plate shown in FIG. 9.

### DETAILED DESCRIPTION OF THE INVENTION

Hereinafter, a specific mode for carrying out the invention is explained in detail in conjunction with drawings which show several embodiments. In the drawings which are referred to in the explanation made hereinafter, parts having identical functions are given same reference symbols and their repeated explanation is omitted as much as possible.

### Embodiment 1

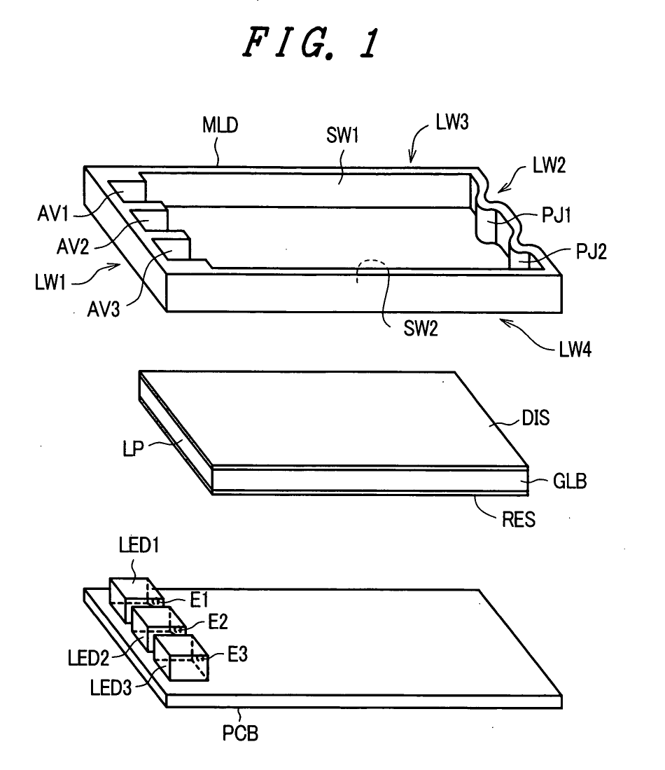

FIG. 1 is a developed perspective view showing the constitution of an essential part excluding a liquid crystal display panel, a housing case and the like for explaining an embodiment 1 of a liquid crystal display device according to the invention. In FIG. 1, a mold case MLD is an approximately rectangular frame-like body. The mold case MLD is, as a whole, made of a resin material having resiliency. In an inner wall of a first side LW1 of the mold case MLD, accommodating portions AV1, AV2, AV3 for accommodating light emitting diodes LED1, LED2, LED3 which constitute light emitting elements are formed. Further, curved projections J1, J2 which project inwardly are formed on a second side LW2 which is a side opposite to the first side LW1 of the mold case MLD.

A third side LW3 and a fourth side LW4 which are arranged close to the first side LW1 and the second side LW2 have inner walls SW1, SW2 which are arranged in parallel to each other. Reference symbol GLB indicates a light guide plate made of a transparent resin material, wherein the light guide plate GLB has a light incident surface LP on a side thereof which faces the accommodating portions AV1, AV2, AV3 of the light emitting diodes in the mold case MLD. Further, on a front surface of the light guide plate GLB (a surface which faces a back surface of the liquid crystal display panel), a light emitting surface (a light diffusion surface) which has a plurality of light diffusion patterns is formed, while on a back surface of the light guide plate GLB, a light reflection surface which has a plurality of light reflection patterns described later is formed. These light diffusion patterns and light reflection patterns are constituted by forming grooves, for example, a plurality of grooves having an approximately V-shaped cross-section on a front and back surfaces of a plate member formed of a transparent resin body by a molding and processing method.

Further, a light diffusion sheet DIS is arranged on the light diffusion surface of the light guide plate GLB by adhesion, while a light reflection sheet RES is arranged on the light reflection surface by adhesion. Here, a light diffusion plate may be used in place of the light diffusion sheet DIS and a light reflection plate may be used in place of the light reflection sheet.

In this embodiment, three light emitting diodes LED1, LED2, LED3 are used as light emitting elements, wherein light emitting portions E1, E2, E3 are mounted on a printed circuit board PCB in an erected manner in a state that the light emitting portions E1, E2, E3 are directed to a light incident surface LP of the light guide plate GLB. Although the printed circuit board PCB may be formed of a hard printed circuit board, in this embodiment, a flexible printed circuit board is used. Although not shown in the drawings, on a back surface of the printed circuit board PCB, a drive IC and other electronic components are mounted.

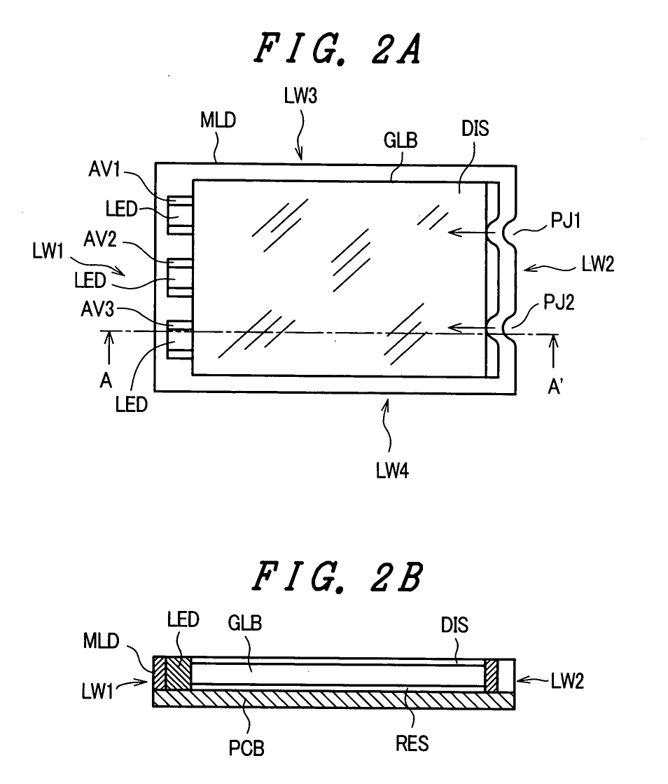

FIG. 2 is an explanatory view of a state in which the light guide plate is housed in the mold case shown in FIG. 1 and the mold case is combined and integrally formed with the printed circuit board which mounts the light emitting diodes thereon, wherein FIG. 2A is a plan view and FIG. 2B is a cross-sectional view taken along a line A-A′ in FIG. 2A. Reference symbols equal to the symbols shown in FIG. 1 correspond to identical functional portions. In assembling them, first of all, the printed circuit board PCB is mounted on the mold case MLD in a state that the light emitting diodes LED1, LED2, LED3 are accommodated in the light-emitting-diode accommodating portions AV1, AV2, AV3 of the mold case MLD. In FIG. 2, although a size of the accommodating portions AV1, AV2, AV3 in the direction along the first side LW1 is set larger than a size of the light emitting diodes LED1, LED2, LED3, when it is necessary to restrict the movement of the light emitting diodes in the direction, this size is set to a value which approximates the corresponding size of the light emitting diodes.

After mounting the printed circuit board PCB, the light incident surface LP (see FIG. 1) of the light guide plate GLB is brought into contact with the light emitting portions of the light emitting diodes LED1, LED2, LED3 and, at the same time, is pushed into the mold case MLD against the curved projections PJ1, PJ2 formed on the second side LW2. The movement of the sides of the light guide plate GLB close to the light incident surface LP is restricted by inner wall surfaces SW1, SW2 (see FIG. 1) of the third side LW3 and the fourth side LW4.

Due to such a structure, a pushing force indicated by an arrow F generated by a resilient force of the curved projections PJ1, PJ2 is always applied to the light guide plate GLB and hence, the light incident surface LP (see FIG. 1) is brought into close contact with the light emitting portions of the light emitting diodes LED1, LED2, LED3 and this close contact state is always maintained. Accordingly, there is no possibility that light irradiated from the light emitting portions of the light emitting diodes LED1, LED2, LED3 leaks to the outside of the light guide plate GLB and, at the same time, there is no possibility that the light is reflected between both of them whereby the light is effectively introduced into the inside of the light guide plate GLB.

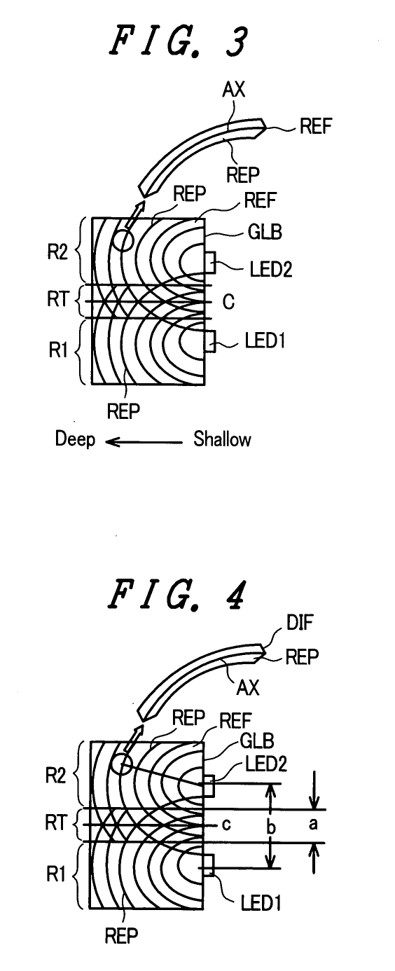

FIG. 3 is a plan view for explaining the constitution of the light guide plate of the embodiment 1 of the liquid crystal display device according to the invention, wherein FIG. 3 shows, together with the light emitting diodes, a back surface side of the light guide plate, that is, a light reflection surface side which constitutes a surface opposite to the liquid crystal display panel and reflects the introduced light toward the light irradiation surface (light diffusion surface) side. Further, FIG. 3 shows a case in which two light emitting diodes are used.

In FIG. 3, on the light reflection surface REF of the light guide plate GLB, in the direction equal to the direction of the irradiation direction (the advancing direction) of the light which is irradiated from the respective light emitting diodes LED1, LED2, a plurality of light reflection patterns REP which are formed of grooves arranged concentrically about the respective light emitting diodes LED1, LED2 and having an approximately V-shaped cross section which have a light reflection function and are recessed toward the light diffusion surface side are formed at an equal pitch within a range of 0.1 mm to 0.5 mm. Here, a pitch size is suitably determined based on a thickness and a size of the light guide plate GLB and a pixel pitch of the liquid crystal display panel.

Further, the plurality of concentric light reflection patterns REP which are formed corresponding to the respective light emitting diodes LED1, LED2 respectively form a first concentric reflection pattern region R1 and a second concentric reflection pattern region R2. Further, both end portions of the plurality of respective light reflection patterns REP which are formed in the first concentric reflection pattern region R1 and the second concentric reflection pattern region R2 which is formed close to the first concentric reflection pattern region R1 are respectively formed in a state that both end portions intersect each other. A light reflection pattern intersecting region RT is formed of the intersecting portions of the respective light reflection patterns REP of both regions R1, R2.

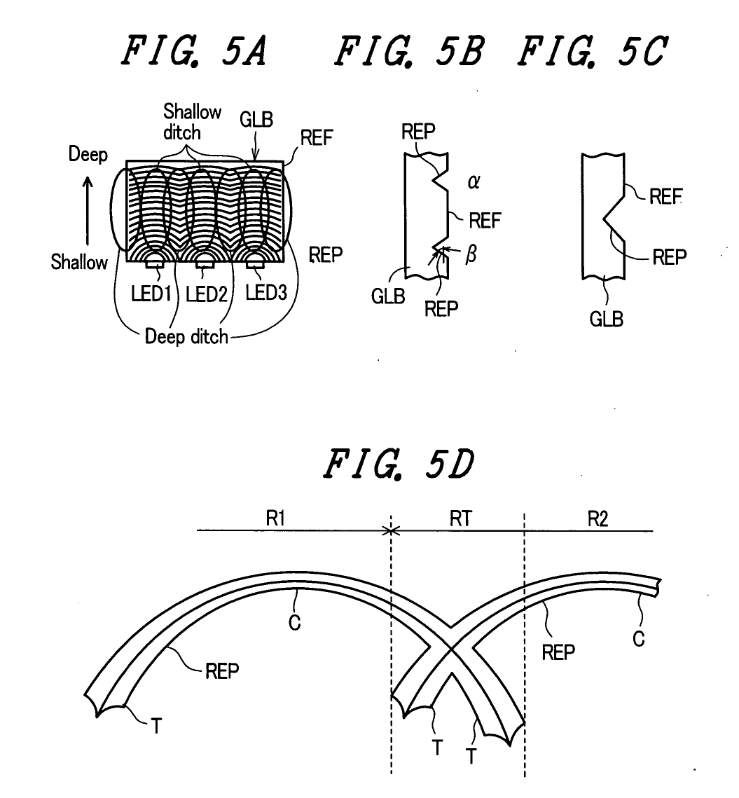

Further, a range that the light reflection pattern intersecting region RT is formed is defined such that, as shown in FIG. 4 which is a plan view of an essential part, assuming a distance between the light emitting diodes LED1 and the light emitting diode LED2 which is arranged close to the light emitting diodes LED1 as b, a region a thereof where the light reflection pattern intersecting region RT is formed is set to a range of 5% to 15% Further, the plurality of light reflection patterns REP which include the grooves formed concentrically on the light reflection surface REF of the light guide plate GLB and having the approximately V-shaped cross section are, as shown in FIG. 5A which is a plan view of an essential part, formed at an equal pitch in the direction equal to the advancing direction of main light beams indicated by an arrow from the respective light emitting diodes LED1, LED2, LED3 side. Further, this embodiment adopts the structure in which a depth of the grooves is set small on the respective light emitting diodes LED1, LED2, LED3 side as shown in FIG. 5B which is an enlarged cross-sectional view of an essential part and the depth of the grooves is gradually increased in the direction toward the advancing direction (arrow direction) of the main light beams as shown in FIG. 5C.

Further, the plurality of light reflection patterns REP including the grooves which are formed in the light reflection pattern intersecting region RT and have an approximately V-shaped cross section are formed, as shown in FIG. 5(d) which is an enlarged perspective view of an essential part, in a state that the depth of the grooves is larger at both end portions T than a center portions C of the light reflection pattern REP. That is, in the light reflection pattern intersecting region RT, at the end portions T of the respective light reflection patterns REP which are formed in the first concentric reflection pattern region R1 and the second concentric reflection pattern region R2, the depth of the grooves is increased.

Here, the size of the grooves having the approximately V-shaped cross section which constitute the concentric light reflection patterns REP is, as shown in FIG. 5B which is an enlarged cross-sectional view of an essential part, is set such that an apical angle α assumes a value which falls within a range of 700 to 1300 and, at the same time, a bottom-side angle β of the V-shaped groove assumes a value which falls within a range of 100 to 55°. Further, the apical angle and the bottom side angle of the grooves of the light reflection patterns REP having the large depth of the grooves shown in FIG. 5C are formed in a size which falls within a substantially equal range as the grooves of the light reflection patterns REP shown in FIG. 5B. The depth of the grooves having the approximately V shaped cross section is set such that the approximately 70% or more of the minimum brightness/maximum brightness is obtained in the light emitting region of the light irradiation surface of the light guide plate GLB and, at the same time, the brightness difference among the respective light emitting diodes LED1, LED2, LED3 becomes approximately 5% or less.

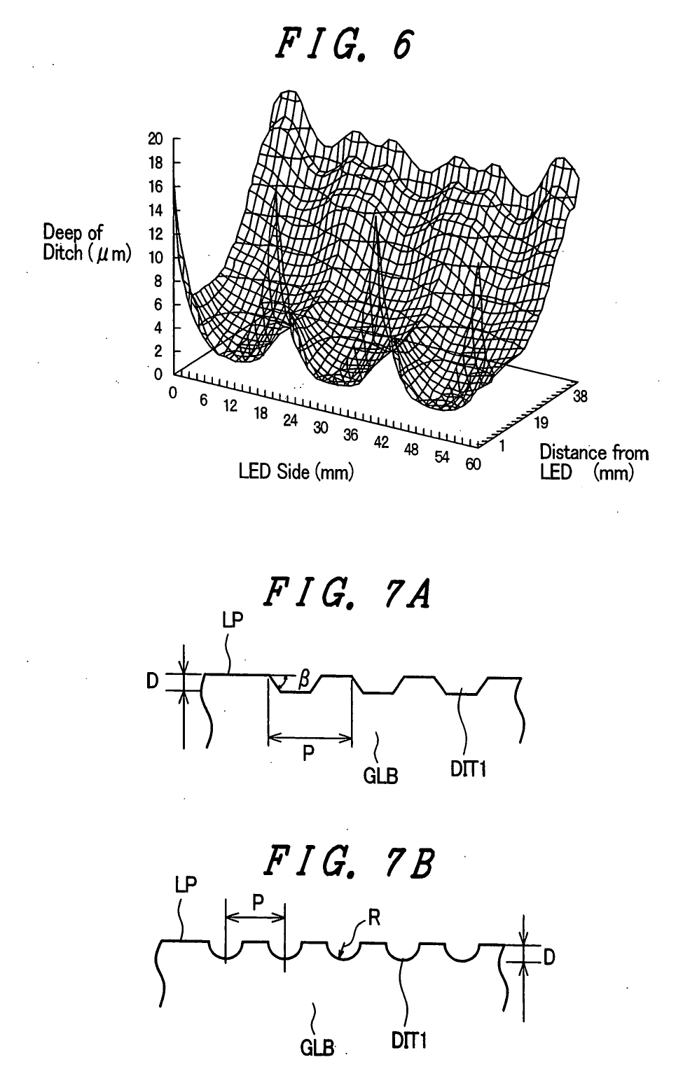

FIG. 6 shows the distribution of the depths of the reflection grooves of the light reflection patterns REP when three light emitting diodes LED1, LED2, LED3 are mounted. As shown in FIG. 6, the grooves having the approximately V-shaped cross section exhibit the small depth of the grooves on the respective light emitting diode LED side and increase the depth of the grooves as the grooves are arranged remoter from the light emitting diodes LED. Further, the depth of the grooves is increased between the respective light emitting diodes LED.

Further, on the light incident surface LP of the light guide plate GLB shown in FIG. 1 with which the respective light emitting diodes LED are brought into contact, along the thickness direction of the guide light plate GLB, as shown in FIG. 7A which is an enlarged cross sectional view of an essential part, recessed portions DIT1 having an approximately trapezoidal shape are formed by a molding and forming method or recessed portions DIT2 having an approximately semicircular shape are formed in the same manner by a molding and forming method as shown in FIG. 7B. The light irradiated from the light emitting diode LED which is incident into the inside of the light guide plate GLB through the recessed portions DIT1 or the recessed portions DIT2 formed in the light incident surface LP and, thereafter, is radiated in the wider directions as much as possible thus enhancing the utilization efficiency of the incident light.

Here, the recessed portions DIT1 having an approximately trapezoidal shape shown in FIG. 7A are formed in size where the depth of the grooves D is set to approximately 0.04 mm, the bottom side angle β is approximately 700 and the pitch P is 0.107 mm. Further, the recessed portions DIT2 having an approximately semicircular shape shown in FIG. 7B are formed in size where the depth of the grooves D is set to approximately 0.04 mm, the radius R is 0.02 mm and the pitch P is 0.8 mm.

In such a constitution, the light reflection patterns REP which form the plurality of grooves having the approximately V-shaped cross section concentrically about the respective light emitting diodes LED1, LED2 corresponding to the respective light emitting diodes LED1, LED2 are formed into the first concentric reflection pattern region R1 and the second concentric reflection pattern region R2 respectively, and the light reflection pattern intersecting region RT where both end portions of the respective light reflection patterns REP intersect each other is formed between the first concentric reflection pattern region R1 and the second concentric reflection pattern region R2 which is arranged close to the first concentric reflection pattern region R1. Accordingly, the light emitted from the respective light emitting diodes LED1, LED2 impinges on the respective concentric light reflection patterns REP perpendicularly and hence, the light is randomly reflected and is diffused by effectively making use of the light whereby the unnaturalness of appearance in the viewing angle direction at the light reflection pattern intersecting region RT which constitutes the portion where the light reflection pattern regions are changed over is reduced thus eliminating the occurrence of the brightness irregularities.

Further, by setting the depth of the grooves of the light reflection patterns REP formed on the light reflection pattern intersecting region RT larger than the depth of the grooves of the light reflection patterns in the first reflection pattern region and the second light reflection pattern region, the unnaturalness of appearance in the viewing angle direction in the light reflection pattern intersecting region RT is reduced whereby the occurrence of the brightness regularities can be completely eliminated. According to an experiment carried out by inventors of the invention, it is confirmed that the brightness can be enhanced by approximately 1.4 times compared to a currently available product.

Further, the pitch of the respective light reflection patterns RFP formed on the concentric light reflection pattern forming regions R1, R2 is set to an equal interval and the depth of the grooves having the approximately V-shaped cross section is increased in the advancing direction of the main light beams of the light emitting diodes LED1, LED2 and hence, a reflection quantity on the light emitting diodes LED1, LED2 side where the light quantity is large can be reduced. Accordingly, the light quantity is decreased in accordance with the direction spreading from the light incident surfaces of the light emitting diodes LED1, LED2 and hence, the reflection quantity can be increased whereby the brightness balance is corrected and the uniform reflection light can be obtained over the whole surface of the light reflection surface REF.

Here, in the above-mentioned embodiments, the explanation has been made with respect to the case in which all of both end portions of the light reflection patterns REP on both sides which constitute the light reflection pattern intersecting region RT formed between the first concentric reflection pattern region R1 and the second concentric reflection pattern region R2 are made to intersect each other. However, the invention is not limited to such a case and it is needless to say that even when both end portions of the light reflection patterns RFP intersect each other for every one other or every plural other, it is possible to obtain advantageous effects substantially equal to the above-mentioned effects.

Further, in the above-mentioned embodiment, the explanation has been made with respect to the case in which plurality of light reflection patterns REP formed of the concentric grooves having the approximately V-shaped cross section are formed on the light reflection surface REF of the light guide plate. However, the light diffusion patterns having the substantially equal structure as the light reflection patterns REP may be formed on the light irradiation surface (light diffusion surface) of the light guide plate GLB. In such a constitution, the brightness irregularities among the respective light emitting diodes LED1, LED2, LED3 can be further efficiently reduced.

Here, in the above-mentioned embodiment, the explanation has been made with respect to the case in which the grooves having the approximately V-shaped cross section are used as the recessed grooves formed in the light reflection patterns REP. However, the invention is not limited to such a case and it is needless to say that even when peaked (crest-like) patterns having an approximately triangular cross section are used in place of the grooves having the approximately V-shaped cross section, it is possible to obtain advantageous effects equal to the above-mentioned advantageous effects.

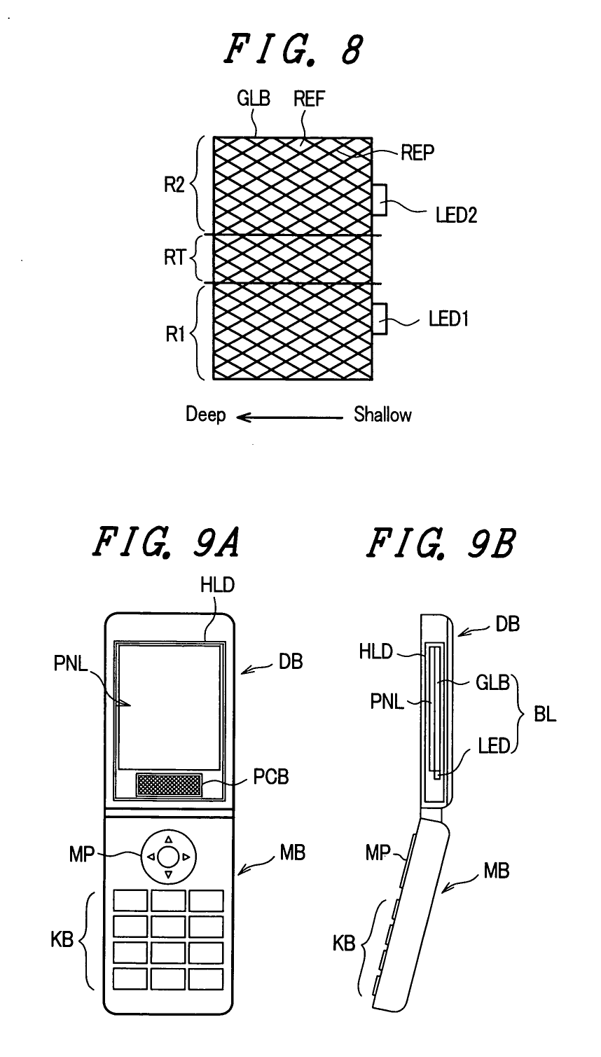

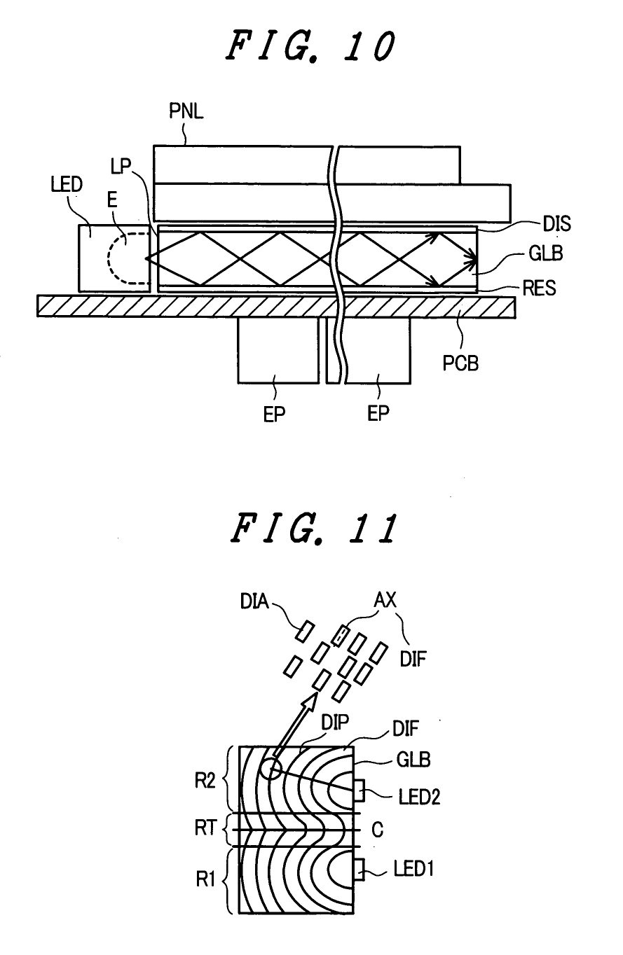

FIG. 8 is a plan view showing another constitutional example of the light guide plate of the liquid crystal display device of the invention, wherein parts identical with the parts shown in the above-mentioned drawings are given the same symbols and their explanation is omitted. In FIG. 8, the constitution which makes this constitutional example different from the constitutional example shown in FIG. 3 lies in that a plurality of linear light reflection patterns REP formed of grooves having an approximately V-shaped cross section are made to intersect each other in the oblique directions with an equal pitch interval in a mesh form on the light reflection surface REF of the light guide plate GLB, a depth of the grooves is set small at respective light emitting diodes LED1, LED2, LED3 side, and the depth of the grooves is gradually increased toward the advancing direction (arrow direction) of the main light beams.

Further, in these light reflection patterns REP, a first light reflection pattern region R1 and a second light reflection pattern region R2 are formed corresponding to the respective light emitting diodes LED1, LED2, and in the light reflection pattern intersecting region RT which is formed between the first light reflection pattern region R1 and the second light reflection pattern region R2, the depth of the grooves of the light reflection patterns REP is set large.

Also in the light guide plate GLB having such a constitution, the light emitted from the respective light emitting diodes LED1, LED2 impinges on the respective light reflection patterns REP perpendicularly and hence, the light is randomly reflected and is diffused whereby the unnaturalness of appearance in the viewing angle direction at the light reflection pattern intersecting region RT which constitutes the portion where the light reflection pattern regions are changed over is reduced thus eliminating the occurrence of the brightness irregularities.

FIG. 9 is a view for explaining a constitutional example of a mobile phone on which the liquid crystal display device of the invention is mounted. The mobile phone is of a foldable type which is constituted of a body casing portion MB and a display part body DB. In the body casing portion MB, a transmission/reception circuit, a data processing circuit and the like are incorporated, while a keyboard KB, a function manipulation buttons MP and the like are mounted on a surface thereof. Further, in the display part body DB, a liquid crystal display panel PNL which is constituted by sandwiching a liquid crystal layer between a pair of transparent substrates which have electrodes for forming pixel on inner surfaces thereof, a printed circuit board PCB, and a backlight device BL which is constituted of the light guide plate GLB explained in the above-mentioned embodiment which forms the light reflection patterns REP which are constituted of concentric grooves having the approximately V-shaped cross section on the light reflection surface REF, the light emitting diodes LED and the like are mounted on and are housed in a holder HLD.

In the liquid crystal display device having such a constitution, with respect to the liquid crystal display panel PNL, the reflection light of high brightness having no brightness difference is diffused from the backlight device BL which is constituted of the light guide plate GLB, the light emitting diodes LED and the like which are explained in conjunction with the embodiment 1 and hence, it is possible to obtain the beautiful display image which exhibits the high brightness and no brightness irregularities.

Here, in the above-mentioned embodiment, the explanation has been made with respect to the case in which the invention is applied to the mobile phone on which the liquid crystal module which uses the liquid crystal display device having the LED backlight device BL is mounted. However, even when the invention is applied to a display device which uses such a liquid crystal display panel such as a liquid crystal television set, a liquid crystal car navigation system, a monitor for digital media use, a liquid crystal monitor for medical use, a liquid crystal monitor for printing/designing use, the invention can obtain advantageous effects substantially equal to the above-mentioned advantageous effects.

According to the invention, by forming the light reflection pattern intersecting region where the end portions of the light reflection patterns intersect each other between the first light reflection pattern region and the second light reflection pattern region, all lights irradiated from the respective light emitting elements impinge on the respective light reflection patterns perpendicularly and are reflected and are diffused and hence, the boundary between the first light reflection pattern region and the second light reflection pattern region in the viewing angle direction on the light irradiation surface of the light guide plate hardly generates the brightness difference whereby it is possible to obtain the extremely excellent advantageous effects including the enhancement of the display quality attributed to the acquisition of the display image which exhibits the high brightness and no brightness irregularities.

Further, by preferably allowing the light reflection pattern intersecting region to set a range thereof to 5% to 15% of the distance between the light emitting elements, the boundary of brightness difference is hardly generated between the first light reflection pattern region and the second light reflection pattern region whereby it is possible to obtain the extremely excellent advantageous effects including the suppression of the brightness irregularities.

Further, by preferably setting the arrangement pitch of the light reflection patterns to the equal interval and by increasing the depth of grooves as the groove is separated from the light emitting elements, it is possible to increase the light reflection quantity in the direction spreading from front surfaces of the respective light emitting elements and hence, the in-plane brightness in the viewing angle direction can be made uniform whereby it is possible to obtain the extremely excellent advantageous effects including the suppression of the brightness irregularities.

Further, by preferably setting the depth of the grooves of the light reflection patterns formed in the light reflection pattern intersecting region larger than the depth of the light reflection patterns formed in the first light reflection pattern region and the second light reflection pattern region, it is possible to increase the light reflection quantity in the direction spreading from front surfaces of the respective light emitting elements and hence, the in-plane brightness in the viewing angle direction can be made uniform whereby it is possible to obtain the extremely excellent advantageous effects including the suppression of the brightness irregularities.

1. A liquid crystal display device comprising:
a liquid crystal display panel being configured to sandwich a liquid crystal layer between a pair of transparent substrates which have electrodes for forming pixels on inner surfaces thereof;
a light guide plate which is mounted on a back surface of the liquid crystal display panel and includes a light irradiation surface which diffuses light by developing the light in a planar shape on a front surface thereof which faces the liquid crystal display panel in an opposed manner and a light reflection surface which reflects light to the light irradiation surface on a back surface thereof arranged opposite to the light irradiation surface; and
a plurality of light emitting elements which are mounted on a side wall of the light guide plate and irradiate light in the inside of the light guide plate, wherein
on the light reflection surface, a plurality of light reflection patterns having concentric grooves about the light emitting elements in the direction equal to the advancing direction of respective main light beams of the light emitting elements are formed in a state that the plurality of light reflection patterns are divided into a first light reflection pattern region and a second light reflection pattern region corresponding to the light emitting elements, and between the first light reflection pattern region and a second light reflection pattern region, a light reflection pattern intersecting region where end portions of the light reflection patterns intersect each other is defined.

2. A liquid crystal display device according to claim 1, wherein the grooves which form the light reflection patterns are grooves having an approximately V-shaped cross section.

3. A liquid crystal display device according to claim 1, wherein the light reflection pattern intersecting region has a region thereof set to a range of 5% to 15% of a distance b between the light emitting elements.

4. A liquid crystal display device according to claim 1, wherein the light reflection patterns are formed with an arrangement pitch of an equal interval and a depth of the grooves is increased in the direction equal to the advancing direction of the main light beams of the light emitting elements.

5. A liquid crystal display device according to claim 1, wherein a depth of the grooves of the light reflection patterns formed in the light reflection pattern intersecting region is larger than a depth of the light reflection patterns formed in the first light reflection pattern region and the second light reflection pattern region.

6. A liquid crystal display device according to claim 1, wherein the plurality of light emitting elements are constituted of a spot-light-source light emitting element.

7. A liquid crystal display device according to claim 6, wherein the spot-light-source light emitting element is a light emitting diode.
